(19) United States
(12) Patent Application Publication
(10) Pub. No.: US 2023/0350068 A1
(43) Pub. Date: Nov. 2, 2023

(54) DISTANCE MEASURING DEVICE

(71) Applicant: Panasonic Intellectual Property Management Co., Ltd., Osaka (JP)

(72) Inventors: Shigeru SAITOU, Kyoto (JP); Shinzo KOYAMA, Osaka (JP); Yusuke YUASA, Kyoto (JP)

(21) Appl. No.: 18/220,958

(22) Filed: Jul. 12, 2023

Related U.S. Application Data
(63) Continuation of application No. PCT/JP2021/047387, filed on Dec. 21, 2021.

(30) Foreign Application Priority Data
Jan. 27, 2021 (JP) 2021-011369

(51) Int. Cl. G01S 17/894; G01S 7/4865; G06T 7/11; G06V 10/75; G06T 7/50

(52) U.S. Cl. CPC G01S 17/894; G01S 7/4865; G06T 7/11; G06V 10/751; G06T 7/50; G06T 2207/10028; G06T 2207/20021

(57) ABSTRACT

The present disclosure allows evaluation on the reliability of a distance value in a distance image, using a distance measuring device that generates a distance image from a plurality of section images. A reliability calculator obtains a maximum signal amount and a background signal amount from signal amounts in the section images for each pixel of the distance image to calculate, as reliability of distance determination, a difference between the maximum signal amount and the background signal amount. As the reliability of distance determination, an analog amount can be obtained which serves as an index of the reliability of the distance value indicated by the distance image.

### CROSS-REFERENCE TO RELATED APPLICATIONS

This is a continuation of International Application No. PCT/JP2021/047387 filed on Dec. 21, 2021, which claims priority to Japanese Patent Application No. 2021-011369 filed on Jan. 27, 2021. The entire disclosures of these applications are incorporated by reference herein.

### BACKGROUND

The present disclosure relates to a distance measuring device that generates distance image data, using section images generated in a plurality of distance zones.

Japanese Patent No. 6427998 discloses, as a distance measuring device, a configuration for obtaining a time of flight (ToF) distance image and a distance image estimated from the brightness and outputting the distance image estimated from the brightness, if the ToF distance image has a distance variation larger than a predetermined threshold.

### SUMMARY

The configuration according to Japanese Patent No. 6427998 merely has the function of selecting a distance image with a small variation. In addition, the distance variation is calculated from the ToF distance image. It is thus difficult to separate the true distance value from the distance variation when, for example, a small object is actually present or an object is moving between frames. If possible, the reliability of the distance value can be evaluated properly for each area of the distance image in one preferred embodiment.

The present disclosure was made in view of the problems. It is an objective of the present disclosure to properly evaluate the reliability of a distance value in a distance image, using a distance measuring device that generates a distance image from a plurality of section images.

A distance measuring device according to an aspect of the present disclosure includes: a distance image generator configured to generate a distance image based on a plurality of section images divided for respective distances from an imaging area; and a reliability calculator configured to obtain, for each pixel of the distance image: as a maximum signal amount, a largest signal amount or an average of a plurality of largest signal amounts out of signal amounts in the plurality of section images; and as a background signal amount, an average of signal amounts excluding the signal amount(s) used for obtaining the maximum signal amount out of the signal amounts in the plurality of section images to calculate, as reliability of distance determination, a difference between the maximum signal amount and the background signal amount.

The present disclosure allows proper evaluation on the reliability of a distance value in a distance image.

### BRIEF DESCRIPTION OF THE DRAWINGS

FIG. 1 shows an example configuration of a whole system of a distance measuring device according to an embodiment.

FIG. 2, (a) and (b) show how to derive the reliability of distance determination in the embodiment.

FIG. 3 shows an example reliability map.

FIG. 4 shows an example object attribute that is recognizable in the embodiment.

FIG. 5 shows an example operation of the distance measuring device in the embodiment.

### DETAILED DESCRIPTION

(Summary)

A distance measuring device according to a first aspect of the present disclosure includes: a distance image generator configured to generate a distance image based on a plurality of section images divided for respective distances from an imaging area; and a reliability calculator configured to obtain, for each pixel of the distance image: as a maximum signal amount, a largest signal amount or an average of a plurality of largest signal amounts out of signal amounts in the plurality of section images; and as a background signal amount, an average of signal amounts excluding the signal amount(s) used for obtaining the maximum signal amount out of the signal amounts in the plurality of section images to calculate, as reliability of distance determination, a difference between the maximum signal amount and the background signal amount.

With this configuration, the reliability calculator obtains the maximum signal amount and the background signal amount from the signal amounts in the section images for each pixel of the distance image to calculate, as the reliability of distance determination, the difference between the maximum signal amount and the background signal amount. Accordingly, as the reliability of distance determination, an analog amount can be obtained which serves as an index of the reliability of the distance value indicated by the distance image.

In the distance measuring device according to the first aspect, the reliability calculator may generate a reliability map representing the reliability of distance determination corresponding to an area of the distance image.

Accordingly, the reliability map is generated which corresponds to the area of the distance image.

In the distance measuring device according to the first aspect, the reliability calculator may include: an object recognizer configured to recognize an object attribute based on a pattern of the signal amounts in the plurality of section images for a predetermined area in the reliability map.

Accordingly, an object attribute can be recognized which is not recognizable simply on the distance image.

The object attribute recognized by the object recognizer may include at least a retroreflective object or a high-brightness light emitting object.

This can improve the accuracy in detecting the retroreflective object or the high-brightness light emitting object.

A distance measuring device according to a second aspect of the present disclosure includes: a distance image generator configured to generate a distance image based on a plurality of section images divided for respective distances from an imaging area; and an object recognizer configured to recognize a retroreflective object by comparing a pattern of signal amounts in the plurality of section images to a pattern of the signal amounts changing with a distance with respect to a limit of diffuse reflectance for a predetermined area in the distance image.

With this configuration, the object recognizer can detect the retroreflective object accurately.

An embodiment will be described in detail with reference to the drawings.

The embodiment described below shows a general or specific example. The numerical values, shapes, materials, components, the arrangement and connection of the components, steps, step orders etc. shown in the following embodiment are thus mere examples, and are not intended to limit the scope of the present disclosure. Among the components described in the following embodiment, those not recited in the independent claims which embody the broadest concept of the present disclosure will be described as optional.

### Embodiment

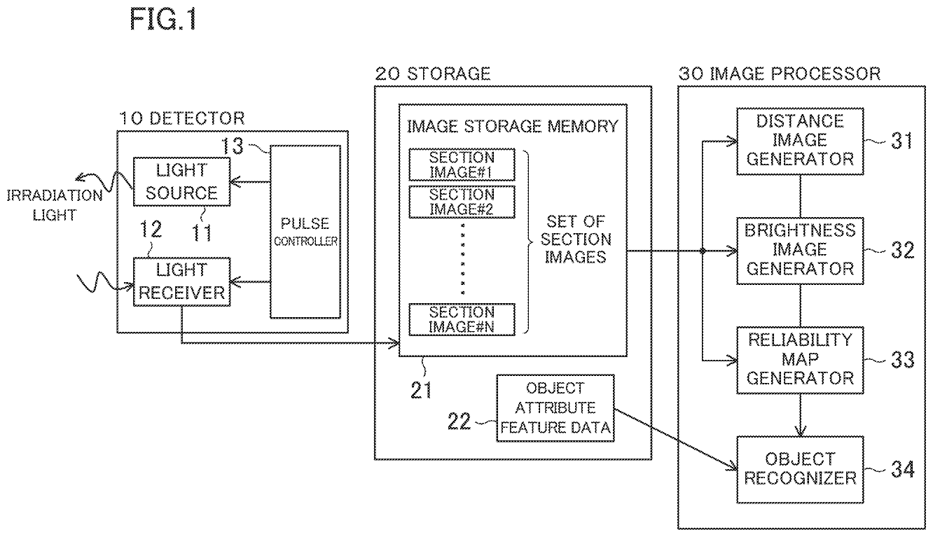

FIG. 1 is a block diagram showing an example configuration of a whole system of a distance measuring device according to the embodiment. Specifically, a space to be imaged, that is, an imaging area, is divided into a plurality of distance zones (referred to as “sections”), based on the distances in depth from a reference point. For the distance zones, section images are generated according to the intensity of reflected irradiation light. Based on the plurality of section images (referred to as a “set of section images”), a distance image and a brightness image are generated. Note that the distance measuring device according to the embodiment not necessarily generates a brightness image.

A detector 10 generates a set of section images based on what is called a “time-of-flight (ToF) method, and includes a light source 11, a light receiver 12, and a pulse controller 13. The light source 11 emits pulsed irradiation light to a target space. The light receiver 12 receives reflected irradiation light in each distance zone. The pulse controller 13 controls times when the light source 11 emits light and when the light receiver 12 receives light.

A storage 20 includes an image storage memory 21 for storing the set of section images generated by the detector 10. The storage 20 stores object attribute feature data 22 for use in object recognition processing, which will be described later.

An image processor 30 includes a distance image generator 31, a brightness image generator 32, a reliability map generator 33, and an object recognizer 34. The distance image generator 31 generates a distance image including pixels with distance values, using the set of section images stored in the image storage memory 21. The brightness image generator 32 generates a brightness image including pixels with brightness values, using the set of section images stored in the image storage memory 21.

The reliability map generator 33 as a reliability calculator obtains the reliability of distance determination, which will be described later, for each pixel, and generates a reliability map indicating the reliability of distance determination corresponding to an area of a distance image. The object recognizer 34 recognizes the attribute of an object in a target space, using the object attribute feature data 22 stored in the storage 20, based on the set of section images and the reliability of distance determination obtained by the reliability map generator 33. Note that the reliability calculator according to the present disclosure may include the reliability map generator 33 and the object recognizer 34.

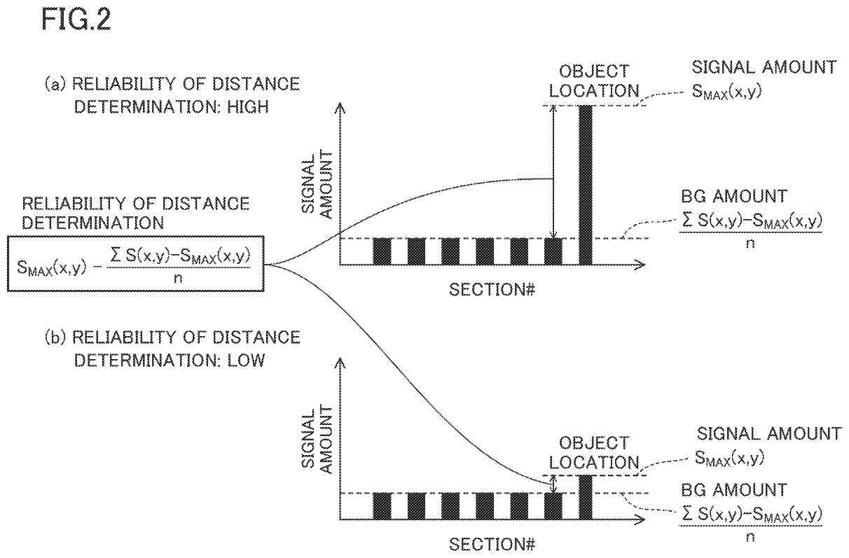

FIG. 2 shows how to derive the reliability of distance determination in the embodiment. Here, assume that the detector 10 generates N section images 1 to N, and a value (a signal amount of reflected light) of each section image at a pixel (x, y) is Si (x, y), where i ranges from 1 to N. N is 15, for example. Assume that Si (x, y), where i ranges from 1 to N, is the maximum when i=MAX is satisfied with a maximum value SMAX (x, y). The location of the section image MAX is estimated as the distance value of an object in the pixel (x, y).

$${S}_{MAX} ( x , y ) - \frac{\sum S ( x , y ) - {S}_{MAX} ( x , y )}{n} \qquad [ Formula 1 ]$$

In this embodiment, the value obtained by subtracting a background signal (BG) amount, which is a signal amount of background light, from the maximum value of the signal amount of the reflected light is defined as the “reliability of distance determination”. n is the number of signal amounts used to calculate the BG amount, and is here represented by the following equation: n=N−1.

As shown in (a) of FIG. 2, if there is a large difference between the signal amount SMAX (x, y) at the object location and the BG amount, the reliability of distance determination is determined to be high. On the other hand, as shown in (b) of FIG. 2, if there is a small difference between the signal amount SMAX (x, y) at the object location and the BG amount, the reliability of distance determination is determined to be low.

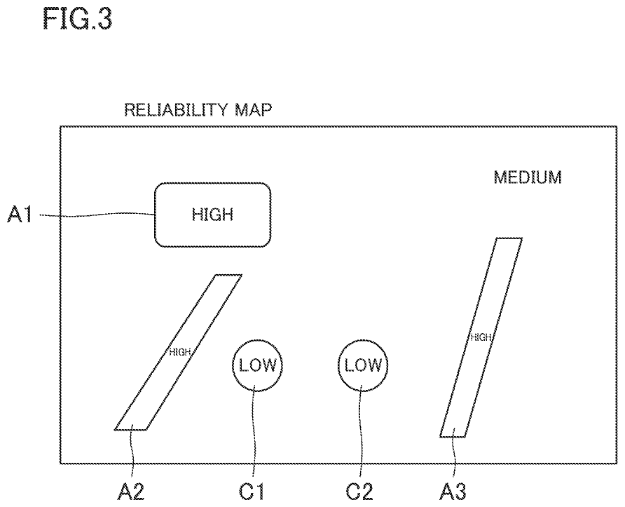

FIG. 3 is an image diagram showing an example reliability map. In the reliability map of FIG. 3, the area corresponding to the distance image is divided into areas with “high”, “medium”, and “low” reliability of distance determination. Here, an area A1 corresponds to a road sign, for example, and areas A2 and A3 correspond to white lines on a road, for example. Areas C1 and C2 correspond to headlamps of vehicles, for example. While the reliability of distance determination is divided into three levels in FIG. 3, how to represent the reliability of distance determination in the reliability map is not limited to thereto.

In this embodiment, object information that is unclear only from the distance image is obtained based on the reliability of distance determination and the pattern of the signal amounts in respective sections. Examples of the object attribute that can be specified in this embodiment include a retroreflective object and a high-brightness light emitting object.

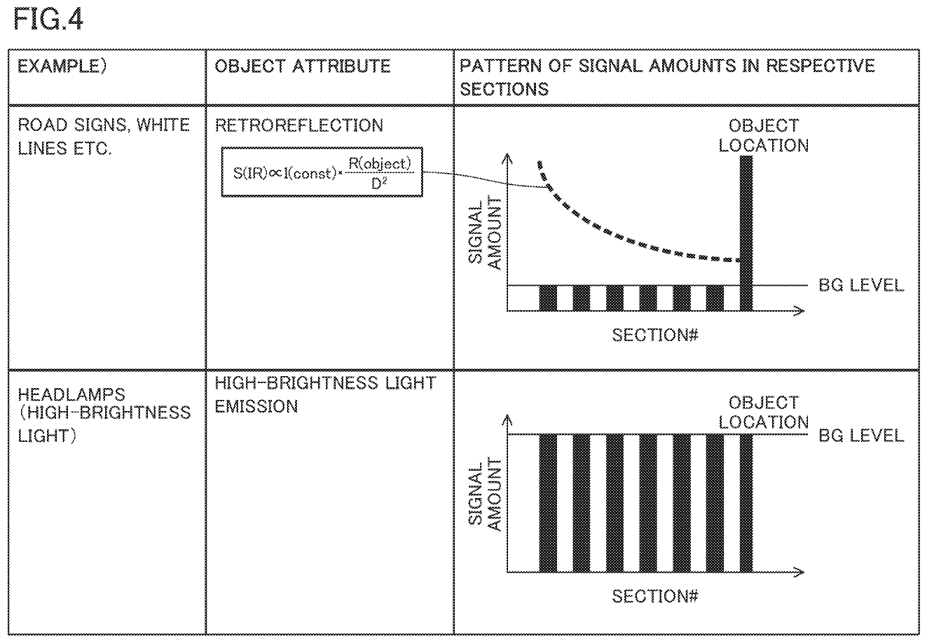

As shown in FIG. 4, for example, road signs, white lines etc. cause retroreflection. The retroreflective object reflects a signal amount exceeding the limit (100%) of diffuse reflectance even at a distance. In order to detect a retroreflective object, the pattern of the signal amounts in the section images is compared with the pattern of the signal amounts changing with a distance with respect to the limit of diffuse reflectance. Specifically, for the pattern of the signal amounts in the respective sections, a line indicating the limit of diffuse reflectance is plotted. The limit of diffuse reflectance is represented by the following equation.

$$S ( IR ) ∝ I ( const ) \cdot \frac{R ( object )}{{D}^{2}} \qquad [ Formula 2 ]$$

Here, I(const) is the intensity of irradiation light, R(object) is the maximum value of the diffuse reflectance, and D is the distance. If the signal amount at an object location greatly exceeds this line, the object is identified as a retroreflective object. Examples of the object attribute feature data 22 stored in the storage 20 include data representing a line indicating the limit of diffuse reflectance, a threshold of a deviation of the signal amount at the object location from the line indicating the limit of diffuse reflectance.

For example, the headlamps of a vehicle are high-brightness light emitting objects. Since a high-brightness light emitting object has a small difference between the maximum value of the intensity of reflected light and the BG amount, specifying the object location is difficult. The BG amount is however significantly large. For example, an object with a low reliability of distance determination, which has been described above, and a significantly large BG amount, is specified as a “high-brightness light emitting object.” Examples of the object attribute feature data 22 stored in the storage 20 include the threshold of the low reliability of distance determination and the threshold of the high BG amount.

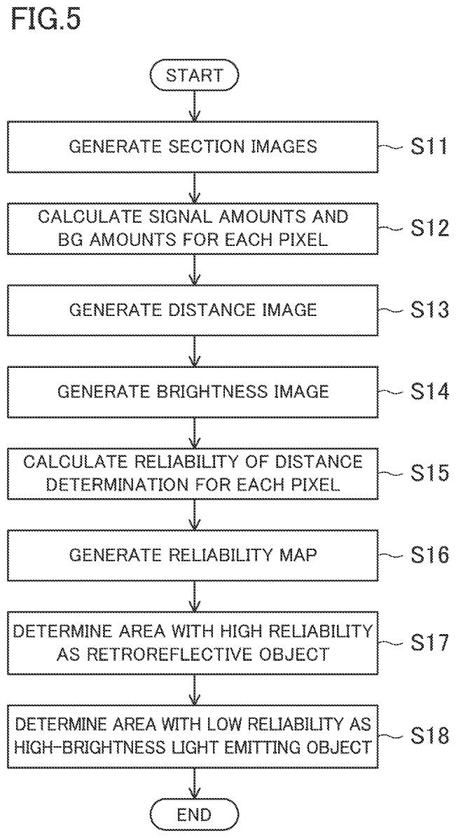

FIG. 5 is a flowchart showing an example operation of the distance measuring device according to this embodiment. First, the detector 10 repeatedly performs an operation, in which the light source 11 emits irradiation light and the light receiver 12 receives reflected light, to generate a set of section images (S11). The generated set of section images is stored in the image storage memory 21 of the storage 20.

Next, the distance image generator 31 calculates the signal amounts and the BG amounts in all sections for each pixel (S12), and generates a distance image based on the calculated signal amounts and BG amounts (S13). The brightness image generator 32 combines the brightness based on the set of section images, and generates a brightness image (S14).

Next, the reliability map generator 33 calculates the reliability of distance determination described above for each pixel based on the signal amounts and the BG amounts (S15), and generates a reliability map as shown in FIG. 3 (S16).

Next, the object recognizer 34 determines, as a retroreflective object, an area with a high reliability of distance determination in the reliability map (S17). Here, for example, in the reliability map of FIG. 3, the areas A1, A2, and A3 are recognized as retroreflective objects. The object recognizer 34 also determines, as a high-brightness light emitting object, an area with a low reliability of distance determination in the reliability map (S18). Here, for example, in the reliability map of FIG. 3, the areas C1 and C2 are specified as high-brightness light emitting objects.

As described above, according to this embodiment, the distance measuring device includes the reliability map generator 33 as a reliability calculator. The reliability map generator 33 obtains the maximum signal amount and a background signal amount from signal amounts in the section images for each pixel of a distance image to calculate, as the reliability of distance determination, a difference between the maximum signal amount and the background signal amount. Accordingly, as the reliability of distance determination, an analog amount can be obtained which serves as an index of the reliability of the distance value indicated by the distance image. Accordingly, the object recognizer 34 recognizes an object attribute that is not recognizable only from the distance image.

How to derive the reliability of distance determination is not limited to what has been described above. For example, the reliability of distance determination may be derived using, as the maximum signal amount, the average of largest signal amounts in some sections in place of the maximum signal amount in all sections. In this case, the average of signal amounts excluding the signal amount(s) used for obtaining the maximum signal amount out of the signal amounts in the section images may be obtained as a background signal amount.

The object recognition processing described above may be performed without using the reliability of distance determination. For example, the retroreflective object determination may be performed in all areas of a distance image or in a predetermined area of a distance image, regardless of the reliability of distance determination.

The reliability of distance determination can also be used for other purposes. For example, the reliability can be used for scene recognition or environment recognition of a space to be imaged. For example, the reliability of distance determination can be used for distinguishing areas inside and outside a tunnel, distinguishing sunny and shade sides, or other areas.

The determination of the retroreflective object is also applicable to detect a helmet of a road construction worker, for example. This can be used to improve the detection accuracy in identifying a person, for example.

The distance measuring device according to the present invention can evaluate the reliability of a distance value in a distance image, and is thus useful for improving the accuracy of distance measurement, for example.

What is claimed is:

1. A distance measuring device comprising:
a distance image generator configured to generate a distance image based on a plurality of section images divided for respective distances from an imaging area; and
a reliability calculator configured to, for each pixel of the distance image:
obtain, as a maximum signal amount, a largest signal amount or an average of a plurality of largest signal amounts out of signal amounts in the plurality of section images;
obtain, as a background signal amount, an average of signal amounts excluding the signal amount(s) used for obtaining the maximum signal amount out of the signal amounts in the plurality of section images; and
calculate, as reliability of distance determination, a difference between the maximum signal amount and the background signal amount.

2. The distance measuring device of claim 1, wherein
the reliability calculator
generates a reliability map representing the reliability of distance determination corresponding to an area of the distance image.

3. The distance measuring device of claim 2, wherein
the reliability calculator includes:
an object recognizer configured to recognize an object attribute based on a pattern of the signal amounts in the plurality of section images for a predetermined area in the reliability map.

4. The distance measuring device of claim 3, wherein
the object attribute recognized by the object recognizer includes at least a retroreflective object or a high-brightness light emitting object.

5. A distance measuring device comprising:
a distance image generator configured to generate a distance image based on a plurality of section images divided for respective distances from an imaging area; and
an object recognizer configured to recognize a retroreflective object by comparing a pattern of signal amounts in the plurality of section images to a pattern of the signal amounts changing with a distance with respect to a limit of diffuse reflectance for a predetermined area in the distance image.
